(19) United States
(12) Patent Application Publication
(10) Pub. No.: US 2013/0162900 A1
(43) Pub. Date: Jun. 27, 2013

(54) AUDIO SIGNAL PROCESSING APPARATUS, AUDIO SIGNAL PROCESSING METHOD, PROGRAM AND SIGNAL PROCESSING SYSTEM

(71) Applicant: SONY CORPORATION, Tokyo (JP)

(72) Inventor: Shiro SUZUKI, Tokyo (JP)

(73) Assignee: SONY CORPORATION, Tokyo (JP)

(21) Appl. No.: 13/664,727

(22) Filed: Oct. 31, 2012

(30) Foreign Application Priority Data
Dec. 27, 2011 (JP) 2011286980

(51) Int. Cl. H04N 11/02

(52) U.S. Cl. 348/423.1; 348/E11.006

(57) ABSTRACT

An audio signal processing apparatus including a selection signal acquisition unit acquiring a selection signal showing a selection of a predetermined moving image from a plurality of moving images imaged at different imaging positions in a predetermined environment; an audio signal generating unit generating an audio signal at the imaging position of the predetermined moving image, based on an audio signal picked up at an audio pick up position in the predetermined environment and a transmission function determined according to a relative position of the imaging position of the predetermined moving image and the audio pick up position according to the selection signal.

### BACKGROUND

The present technology relates to an audio signal processing apparatus, an audio signal processing method, a program and a signal processing system, in particular, to an audio signal processing apparatus and the like handling audio signals at a plurality of imaging positions.

In digital broadcasting, imaging signals and sound signals which are content are packetized and multiplexed after being respectively digitalized and generated as separate streams, and then transmitted from a broadcasting station as a multiplexed stream (refer to Japanese Unexamined Patent Application Publication No. 9-312833, or the like). Here, for convenience of description, description will be given of a “sound signal”; however, this sound signal does not signify a sound signal in the strict sense, but signifies an audio signal including a sound signal.

The multiplexed stream transmitted from the broadcasting station is received by the viewer's home television receiver, and separated into an image stream and a sound stream. Then, image reproduction is performed according to the image signal obtained by decoding the image stream, and sound reproduction is performed according to the sound signal obtained by decoding the sound stream.

Examples of the content may include a broadcast of a piano concert. In such a case, as shown in FIG. 30, a plurality of cameras conveying images are prepared and the viewpoint is switched from time to time. Specifically, the set up includes a camera 1 for capturing the finger movements and facial expressions of the performers, a camera 2 for viewing the whole scene from above, a camera 3 for obtaining a viewpoint from below as if in the audience seats, and a camera 4 for capturing the entire venue from far away.

The upper part of FIG. 31 shows an example of a case where imaging signals from each camera are streamed. In the example, the time point T0 to T1 is the image signal SC1 from camera 1, the time point T1 to T2 is the image signal SC2 from camera 2, the time point T2 to T3 is the image signal SC3 from camera 3, the time point T3 to T4 is the image signal SC4 from camera 4, and finally, T4 up to T5 is the image signal SC1 from camera 1 again. According to switching operation of the cameras, it is possible to convey the finer points, such as the facial expressions of the performers and the overall atmosphere of the venue to the viewers, and it is possible for the viewers to enjoy the piano concert while at home.

On the other hand, there is usually only one microphone (below referred to as a “mic” as appropriate) for transmitting sound, and this is often placed next to the piano. The lower part of FIG. 31 shows an example in which a sound signal is streamed from such a mic. Specifically, from time point T0 to T5 is all taken up by the sound signal SM1 from the mic 1.

### SUMMARY

The reasons why there is only one mic may change according to the circumstances of the content creator; however, for example, the following reasons may be considered. That is, from the mic 1 placed in the vicinity of the piano, it is possible to pick up almost only the sound of the piano. However, camera 2, camera 3, and camera 4 are located at the seats of the audience or near the broadcast staff. Therefore, as shown in FIG. 32, the corresponding mic 2, mic 3, and mic 4 easily pick up the surrounding noise from the periphery thereof as well as the sound of the piano.

Detailed description will be given of the problem. The upper part of FIG. 33 is the same as the upper part of FIG. 31 described above. As shown in the lower part of FIG. 33, in the sound stream, the time point T0 to T1 is the sound signal SM1 from mic 1, the time point T1 to T2 is the sound signal SM2 from mic 2, the time point T2 to T3 is the sound signal SM3 from mic 3, the time point T3 to T4 is the sound signal SM4 from mic 4, and finally, T4 up to T5 is the sound signal SM1 from mic 1 again. In such a case, if the sound of the operation of the lighting apparatus enters mic 2, the sound of someone in the audience clearing their throat enters mic 3, or the sound of the camera staff sneezing enters mic 4, it is possible to easily imagine that there are a limitless number of potential problems.

It is desirable to obtain a high quality sound signal at a plurality of imaging positions.

According to an embodiment of the present technology, there is provided an audio signal processing apparatus including: a selection signal acquisition unit acquiring a selection signal indicating a selection of a predetermined moving image from a plurality of moving images imaged at different imaging positions in a predetermined environment; and an audio signal generating unit generating an audio signal at an imaging position of the predetermined moving image, based on an audio signal picked up at an audio pick up position in the predetermined environment and a transmission function determined according to a relative position of the imaging position of the predetermined moving image and the audio pick up position according to the selection signal.

In the present technology, according to the selection signal acquisition unit, a selection signal is acquired showing the selection of a predetermined moving image from a plurality of moving images imaged at different imaging positions within a predetermined environment. Here, according to the audio signal generation unit, depending on the selection signal, an audio signal is generated at an imaging position of the predetermined moving image. In such a case, based on an audio signal picked up at an audio pick up position in the environment, and a transmission function determined according to a relative position of an imaging position of the predetermined moving image and the audio pick up position, an audio signal is generated at an imaging position of the predetermined moving image.

It is desirable to provide an encoding unit encoding the audio signal generated by the audio signal generating unit and obtaining an audio stream, for example. In such a case, for example, the above-described selection signal acquisition unit and the audio signal generating unit are arranged at the transmission side, and the audio stream obtained by the encoding unit is transmitted to the reception side.

It is desirable to provide a configuration set to include: a stream receiving unit receiving the audio stream obtained by encoding the picked up audio signal and an effect stream obtained by encoding the transmission function corresponding to the imaging position of the predetermined moving image indicated by the selection signal, a first decoding unit decoding the audio stream and obtaining an audio signal, and a second decoding unit decoding the effect stream and obtaining the transmission function. In such a case, for example, the above-described selection signal acquisition unit and the audio signal generating unit are arranged on the reception side, and, on the reception side, an audio signal is generated at the imaging position of the selected predetermined moving image.

In this manner, in the present technology, the audio signal at the imaging position of the selected predetermined moving image is not obtained by the microphone arranged at the imaging position, but is generated based on the audio signal picked up at the audio pick up position and the transmission function. Therefore, it is possible to obtain a high quality audio signal at each imaging position with an audio signal of which the pick up state is good as a base.

Here, in the present technology, for example, when there is a switch of the predetermined moving image indicated by the selection signal, the audio signal generating unit generates the audio signal at the imaging position of the predetermined moving image before the switch and the audio signal of the imaging position of the predetermined moving image after the switch in parallel, and obtains an audio signal of a single system according to a cross-fading process. In such a case, it is possible to prevent the generation of discontinuous noise in joined portions.

It is desirable to provide an audio signal generation unit provided with a control unit controlling stopping or restarting of changes of the transmission function according to the selection signal. In this manner, it is possible to continuously generate and output an audio signal only at the predetermined imaging position.

It is desirable to provide an audio signal generation unit provided with an output selection unit selectively outputting a generated audio signal or a picked up audio signal. In this manner, it is also possible to continuously output the picked up audio signal.

According to an embodiment of the present technology, it is possible to obtain a high quality audio signal at a plurality of imaging positions.

### BRIEF DESCRIPTION OF THE DRAWINGS

FIG. 1 is a block diagram showing a configuration example of a transmitting and receiving system.

FIG. 2 is a block diagram showing a configuration example of a part of a transmitting apparatus configuring the transmitting and receiving system.

FIG. 3 is a diagram showing an audio pick up example.

FIG. 4 is a flow chart showing an example of the flow of the operation of a sound system in a transmitting apparatus.

FIG. 5 is a block diagram showing a configuration example of a part of a receiving apparatus configuring the transmitting and receiving system.

FIG. 6 is a flow chart showing an example of the flow of the operation of the receiving apparatus.

FIG. 7 is a diagram showing an example of an image stream and a sound stream transmitted by the transmitting apparatus.

FIG. 8 is a block diagram showing a configuration example of a transmitting and receiving system as a first embodiment.

FIG. 9 is a block diagram showing a configuration example of a part of a transmitting apparatus configuring the transmitting and receiving system.

FIG. 10 is a diagram showing an audio pick up example in the first embodiment.

FIG. 11 is a diagram showing an example of an image stream and a sound stream transmitted by the transmitting apparatus.

FIG. 12 is a flow chart showing an example of the flow of the operation of a sound system in a transmitting apparatus.

FIG. 13 is a diagram schematically showing the entire transmitting apparatus.

FIG. 14 is a block diagram showing a configuration example of a part of a receiving apparatus configuring the transmitting and receiving system.

FIG. 15 is a flow chart showing an example of the flow of the operation of the receiving apparatus.

FIG. 16 is a block diagram showing a configuration example of a transmitting and receiving system as a second embodiment.

FIG. 17 is a block diagram showing a configuration example of a part of a transmitting apparatus configuring the transmitting and receiving system.

FIG. 18 is a diagram showing an example of an image stream, a sound stream, and an effect stream transmitted by the transmitting apparatus.

FIG. 19 is a flow chart showing an example of the flow of the operation of a sound system in a transmitting apparatus.

FIG. 20 is a diagram showing a configuration example of a part of a receiving apparatus configuring the transmitting and receiving system.

FIG. 21 is a flow chart showing an example of the flow of the operation of the receiving apparatus.

FIG. 22 is a block diagram showing another configuration example of a receiving apparatus configuring the transmitting and receiving system.

FIG. 23 is a flow chart showing an example of the flow of the operation of the receiving apparatus.

FIG. 24 is a block diagram showing another configuration example of a receiving apparatus configuring the transmitting and receiving system.

FIG. 25 is a flow chart showing an example of the flow of the operation of the receiving apparatus.

FIG. 26 is a block diagram showing another configuration example of a receiving apparatus configuring the transmitting and receiving system.

FIG. 27 is a flow chart showing an example of the flow of the operation of the receiving apparatus.

FIG. 28 is a block diagram showing still another configuration example of a receiving apparatus configuring the transmitting and receiving system.

FIG. 29 is a flow chart showing an example of the flow of the operation of the receiving apparatus.

FIG. 30 is a diagram for illustrating an example of the content (broadcast of a piano concert).

FIG. 31 is a diagram showing an example of an image stream and a sound stream.

FIG. 32 is a diagram for illustrating the problem of the content of the piano concert broadcast.

FIG. 33 is a diagram showing an example of an image stream and sound stream for illustrating the problem of the content of the piano concert broadcast.

### DETAILED DESCRIPTION OF EMBODIMENTS

Hereafter, description will be given of forms (below, “embodiments”) for realizing the disclosure. Here, description will be given in the following order.

### 1. First Embodiment

### 2. Second Embodiment

### 3. Modification Examples

### 1. FIRST EMBODIMENT

### Transmitting and Receiving System Using a Plurality of Mics

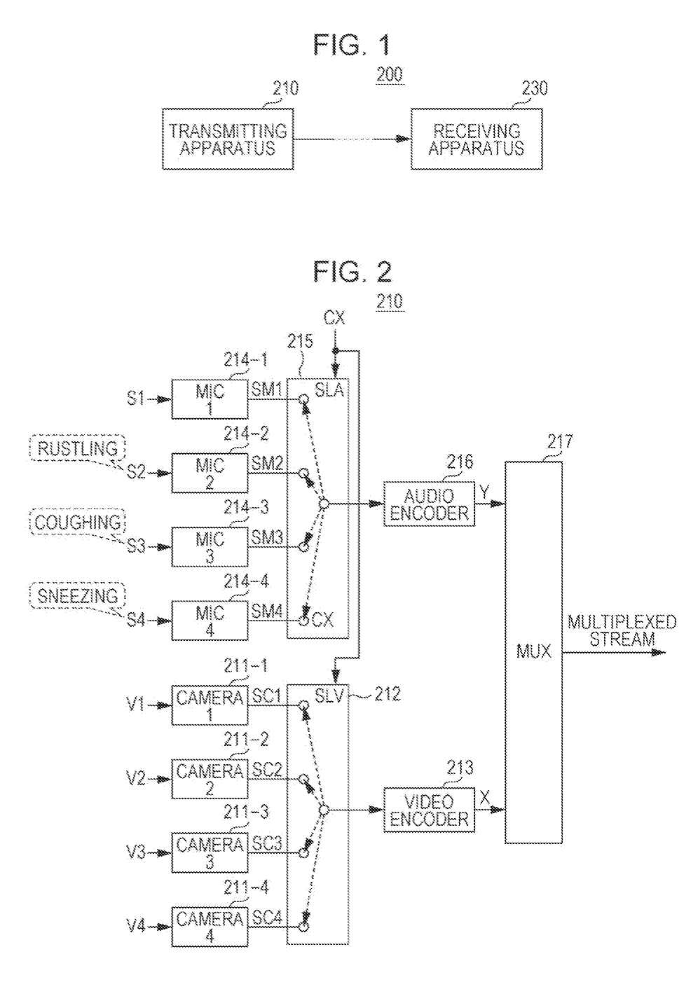

First, description will be given of configuration examples of a transmitting and receiving system using a plurality of mics arranged at a plurality of imaging positions. FIG. 1 shows a configuration example of a transmitting and receiving system 200. This transmitting and receiving system 200 is configured by connecting a transmitting apparatus 210 and a receiving apparatus 230 using wires or wirelessly. For example, in the case of broadcasting, the transmitting apparatus 210 corresponds to the broadcasting station side and the receiving apparatus 230 corresponds to a television receiver in the home.

FIG. 2 shows a configuration example of a part of the transmitting apparatus 210. The transmitting apparatus 210 includes four cameras of a camera (camera 1) 211-1, a camera (camera 2) 211-2, a camera (camera 3) 211-3, and a camera (camera 4) 211-4, a selector (SLV) 212, and a video encoder 213. In addition, the transmitting apparatus 210 includes four mics of a mic (mic 1) 214-1, a mic (mic 2) 214-2, a mic (mic 3) 214-3, and a mic (mic 4) 214-4, a selector (SLA) 215, an audio encoder 216, and a multiplexer (MUX) 217.

The camera 211-1, the camera 211-2, the camera 211-3, and the camera 211-4 are arranged at different imaging positions in a predetermined environment. For example, in a piano concert, the camera (camera 1) 211-1 is a camera for capturing the finger movements and facial expressions of the performers, the camera (camera 2) 211-2 is a camera for viewing the whole scene from above, the camera (camera 3) 211-3 is a camera for obtaining a viewpoint from below as if in the audience seats, and the camera (camera 4) 211-4 is a camera for capturing the entire venue from far away.

From image signals SC1, SC2, SC3, and SC4 of a moving image obtained by imaging images V1, V2, V3, and V4 with each camera, the selector 212 selectively extracts a predetermined image signal according to a camera switching signal CX. The video encoder 213 generates an image stream X by performing encoding of the image signal extracted by the selector 212.

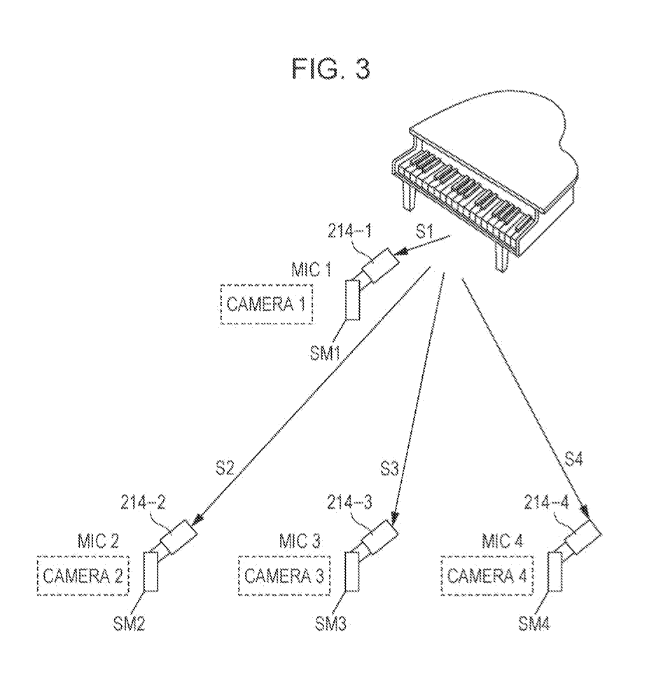

The mic 214-1, the mic 214-2, the mic 214-3, and the mic 214-4 are respectively arranged to be integral with or in the vicinity of the camera 211-1, the camera 211-2, the camera 211-3, and the camera 211-4, and perform pick up at those positions. FIG. 3 shows a picking up example of a case where the mic (mic 1) 214-1, the mic (mic 2) 214-2, the mic (mic 3) 214-3, and the mic (mic 4) 214-4 actually perform picking up.

The mic 214-1 which is arranged near the piano obtains a sound signal SM1 by picking up a sound S1 coming out of the piano. Since the mic 214-2 is separated at a distance from the mic 214-1, a sound signal SM2 is obtained by picking up a sound S2 which is different to the sound S1. In the same manner, the mic 214-3 picks up the sound S3 and obtains a sound signal SM3, and the mic 214-4 picks up the sound S4 and obtains a sound signal SM4.

The selector 215 selectively extracts a sound signal corresponding to an image signal extracted by the selector 212 as described above from the sound signals SM1, SM2, SM3, and SM4 obtained from each mic according to the camera switching signal CX. The audio encoder 216 generates a sound stream Y by performing encoding of the sound signal extracted by the selector 215. The multiplexer 217 respectively packetizes and multiplexes the image stream X and the sound stream Y and generates a multiplexed stream. The transmitting apparatus 210 transmits the multiplexed stream to the receiving side. For example, in the case of broadcasting, the multiplexed stream is transmitted with the broadcast wave.

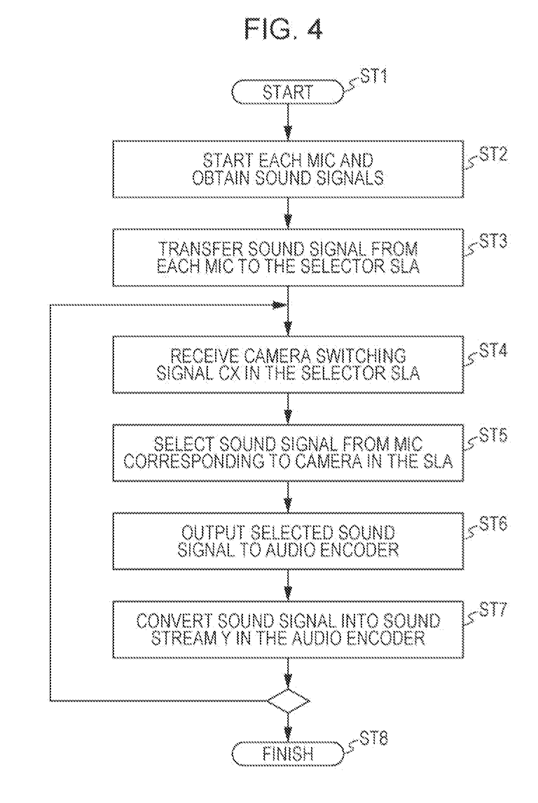

The flowchart of FIG. 4 shows an example of the flow of the operation of the sound system in the transmitting apparatus 210 of FIG. 2 above. First, in step ST1, the process is started, subsequently, in step ST2, each mic is started and the sound signals are obtained. Then, in step ST3, the sound signals from each mic are transmitted to the selector (SLA) 215.

Next, in step ST4, the camera switching signal CX is received by the selector (SLA) 215. In addition, in step ST5, in the selector (SLA) 215, a sound signal is selected from the mic corresponding to the camera switched to by the selector (SLV) 212. In addition, in step ST6, the selected sound signal is output to the audio encoder 216. Then, in step ST7, the encoding of the sound signal is performed in the audio encoder 216 and a sound stream Y is obtained.

The processing from the above-described step ST4 to step ST7 is repeatedly performed. Then, for example, when there is an explicit termination operation from the user, in step ST8, the process is terminated.

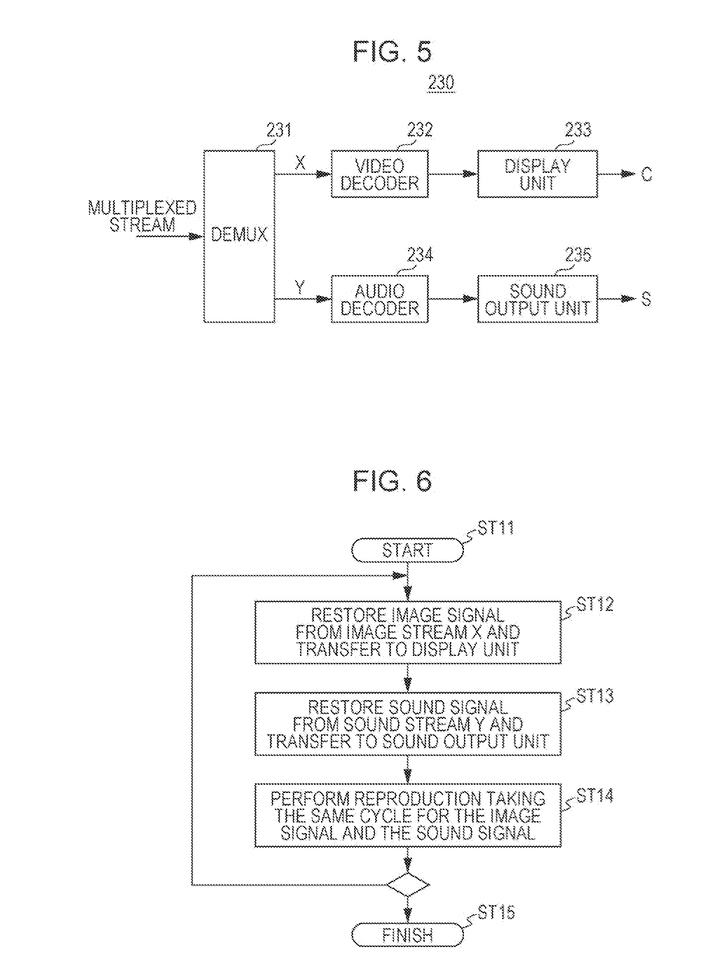

FIG. 5 shows a configuration example of a part of the receiving apparatus 230. The receiving apparatus 230 includes a demultiplexer (DEMUX) 231, a video decoder 232, a display unit 233, an audio decoder 234, and a sound output unit 235. The demultiplexer 231 respectively extracts the image stream X and the sound stream Y from the multiplexed stream sent from the transmitting apparatus 210. For example, in the case of broadcasting, the multiplexed stream is obtained by being received by a digital tuner (not shown).

The video decoder 232 obtains the image signal by decoding the image stream X extracted by the demultiplexer 231. The display unit 233 is configured by a display such as a liquid crystal display device or the like and displays an image C according to the image signal obtained by the video decoder 232. In addition, the audio decoder 234 obtains the sound signal by decoding the sound stream Y extracted by the demultiplexer 231. The sound output unit 235 is configured by a speaker, headphones, or the like, and outputs a sound S according to the sound signal obtained by the audio decoder 234.

The flowchart of FIG. 6 shows an example of the flow of the operation of the receiving apparatus 230 of FIG. 5 above. First, in step ST11, the process is started, subsequently, in step ST12, the image stream X extracted by the demultiplexer 231 is decoded by the video decoder 232 and an image signal is restored, and this image signal is transmitted to the display unit 233. In addition, in step ST13, the sound stream Y extracted by the demultiplexer 231 is decoded by the audio decoder 234 and a sound signal is restored, and this sound signal is transmitted to the sound output unit 235.

Next, in step ST14, in the display unit 233 and the sound output unit 235, synchronization of the image signal and the sound signal is acquired and reproduction is performed. In other words, the image according to the image signal is displayed on the display unit 233, and the sound according to the sound signal is output in the sound output unit 235. Here, the synchronization of the image signal and the sound signal is not described above; however, it is completed by using a Presentation Time Stamp (PTS) or the like inserted into the image stream X and the sound stream Y.

The processing from the above-described step ST12 to step ST14 is repeatedly performed. Then, for example, when there is an explicit termination operation from the user, in step ST15, the process is terminated.

In the case of the transmitting and receiving system 200 of FIG. 1, for example, in the audio pick up example shown in FIG. 3, it is possible to pick up almost only the sound of the piano in the mic 1 placed in the vicinity of the piano. However, camera 2, camera 3, and camera 4 are located at the seats of the audience or near the broadcast staff. Therefore, in the mic 2, the mic 3, and the mic 4, as well as the sound of the piano, the surrounding noise from the periphery thereof is easily picked up.

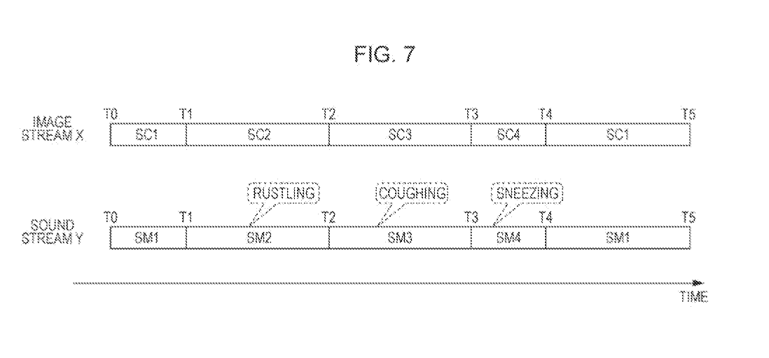

The upper part of FIG. 7 shows an example of the image stream X of a case where imaging signals from each camera are streamed. In the example, the time point T0 to T1 is the image signal SC1 from camera 1, the time point T1 to T2 is the image signal SC2 from camera 2, the time point T2 to T3 is the image signal SC3 from camera 3, the time point T3 to T4 is the image signal SC4 from camera 4, and finally, T4 up to T5 is the image signal SC1 from camera 1 again.

The lower part of FIG. 7 shows an example of the sound stream Y corresponding to the image stream X shown in the upper part. The time point T0 to T1 is the sound signal SM1 from mic 1, the time point T1 to T2 is the sound signal SM2 from mic 2, the time point T2 to T3 is the sound signal SM3 from mic 3, the time point T3 to T4 is the sound signal SM4 from mic 4, and finally, T4 up to T5 is the sound signal SM1 from mic 1 again. In the example of the drawings, it is shown that, in the mic 2, the sound of the operation of the lighting apparatus is also picked up as well as the piano sound, in the mic 3, the sound of someone in the audience clearing their throat is also picked up as well as the piano sound, and, in the mic 4, the sound of the camera staff sneezing is also picked up as well as the piano sound.

### Transmitting and Receiving System Using a Single Mic

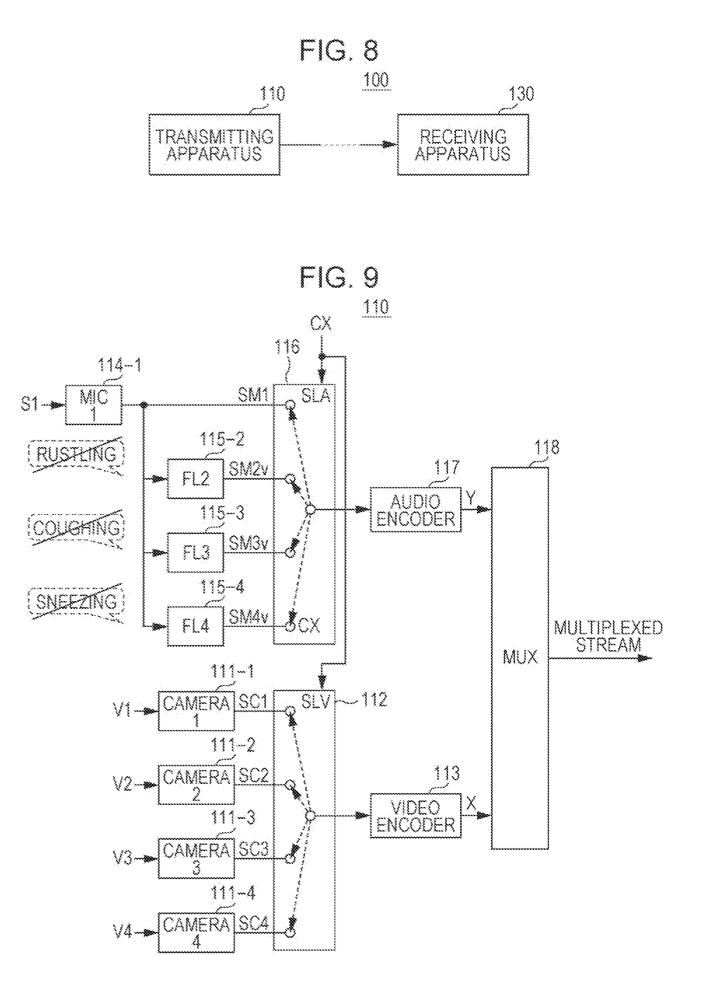

FIG. 8 shows a configuration example of a transmitting and receiving system 100 as the first embodiment. This transmitting and receiving system 100 is configured by connecting a transmitting apparatus 110 and a receiving apparatus 130 using wires or wirelessly. For example, in the case of broadcasting, the transmitting apparatus 110 corresponds to the broadcasting station side and the receiving apparatus 130 corresponds to a television receiver in the home.

FIG. 9 shows a configuration example of a part of the transmitting apparatus 110. The transmitting apparatus 110 includes four cameras of a camera (camera 1) 111-1, a camera (camera 2) 111-2, a camera (camera 3) 111-3, and a camera (camera 4) 111-4, a selector (SLV) 112, and a video encoder 113. In addition, the transmitting apparatus 110 includes a mic (mic 1) 114-1 and three filter units of a filter unit (FL2) 115-2, a filter unit (FL3) 115-3, and a filter unit (FL4) 115-4. In addition, the transmitting apparatus 110 includes a selector (SLA) 116, an audio encoder 117, and a multiplexer (MUX) 118.

The camera 111-1, the camera 111-2, the camera 111-3, and the camera 111-4 are arranged at different imaging positions in a predetermined environment. For example, in a piano concert, the camera (camera 1) 111-1 is a camera for capturing the finger movements and facial expressions of the performers, the camera (camera 2) 111-2 is a camera for viewing the whole scene from above, the camera (camera 3) 111-3 is a camera for obtaining a viewpoint from below as if in the audience seats, and the camera (camera 4) 111-4 is a camera for capturing the entire venue from far away.

From image signals SC1, SC2, SC3, and SC4 of a moving image obtained by imaging images V1, V2, V3, and V4 with each camera, the selector 112 selectively extracts a predetermined image signal corresponding to a camera switching signal CX. The video encoder 113 generates an image stream X by performing encoding of the image signal extracted by the selector 112.

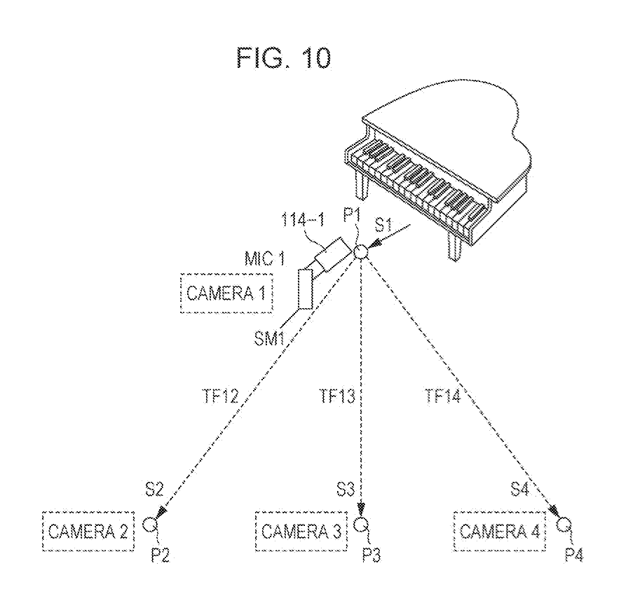

The mic (mic 1) 114-1 is arranged to be integral with or in the vicinity of the camera (camera 1) 111-1, and performs pick up at that position (pick up position). FIG. 10 shows a picking up example of a case where the mic (mic 1) 114-1 actually performs picking up. Here, P1 indicates the imaging position of the camera 1, P2 indicates the imaging position of the camera 2, P3 indicates the imaging position of the camera 3, and P4 indicates the imaging position of the camera 4.

The mic (mic 1) 114-1 which is arranged near the piano obtains a sound signal SM1 by picking up a sound S1 coming out of the piano. Here, the mic is not arranged at positions corresponding to the camera 2, the camera 3, or the camera 4, and does not pick up sounds at the respective positions.

The filter unit (FL2) 115-2 convolutes a transmission function TF12 from the arrangement position of the mic (mic 1) 114-1 to the arrangement position of the camera (camera 2) 111-2 or the vicinity thereof with the sound signal SM1 obtained by the mic (mic 1) 114-1, and generates a sound signal SM2v at the arrangement position of the camera (camera 2) 111-2. The transmission function TF12 is measured in advance.

In addition, the filter unit (FL3) 115-3 convolutes a transmission function TF13 from the arrangement position of the mic (mic 1) 114-1 to the arrangement position of the camera (camera 3) 111-3 or the vicinity thereof with the sound signal SM1 obtained by the mic (mic 1) 114-1, and generates a sound signal SM3v at the arrangement position of the camera (camera 3) 111-3. The transmission function TF13 is measured in advance.

In addition, the filter unit (FL4) 115-4 convolutes a transmission function TF14 from the arrangement position of the mic (mic 1) 114-1 to the arrangement position of the camera (camera 4) 111-4 or the vicinity thereof with the sound signal SM1 obtained by the mic (mic 1) 114-1, and generates a sound signal SM4v at the arrangement position of the camera (camera 4) 111-4. The transmission function TF14 is measured in advance.

Here, the transmission function shows the manner in which the sound emitted from a certain specific position is changed at a different specific position. For example, with the sound observed at a certain point A set as SA, the transmission function shows the manner in which SA is observed at point B. When the sound reaching and observed at point A is set as SA and the transmission function from point A to point B is set to TF, the sound SB at point B is represented by the following formula (I).

SB=SA*TF (1)

In the formula (1), the “*” represents a convolution calculation. The transmission function represented by the time axis is also referred to as an impulse response. Below, unless otherwise noted, in this embodiment, it is assumed that references to the transmission function indicate the impulse response. Here, detailed description of the measurement method of the transmission function, in particular, the measurement method of the impulse response has been omitted; however, it is possible to use one of commonly used methods such as a TSP (Time Stretched Pulse) method or the like.

The selector 116 selectively extracts a sound signal corresponding to an image signal extracted by the selector 112 as described above from the sound signal SM1 obtained by the mic (mic 1) 114-1 and the sound signals SM2v, SM3v, SM4v obtained by the filter units 115-2, 115-3, and 115-4, according to the camera switching signal CX. The audio encoder 117 generates a sound stream Y by performing encoding of the sound signal extracted by the selector 116. The multiplexer 118 respectively packetizes and multiplexes the image stream X and the sound stream Y and generates a multiplexed stream. The transmitting apparatus 110 transmits the multiplexed stream to the receiving side. For example, in the case of broadcasting, the multiplexed stream is transmitted with the broadcast wave.

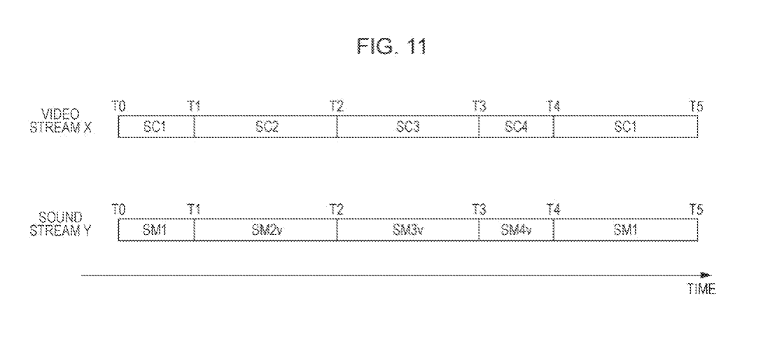

The upper part of FIG. 11 shows an example of the image stream X of a case where imaging signals from each camera are streamed. In the example, the time point T0 to T1 is the image signal SC1 from camera 1, the time point T1 to T2 is the image signal SC2 from camera 2, the time point T2 to T3 is the image signal SC3 from camera 3, the time point T3 to T4 is the image signal SC4 from camera 4, and finally, T4 up to T5 is the image signal SC1 from camera 1 again.

The lower part of FIG. 11 shows an example of the sound stream Y corresponding to the image stream X shown in the upper part. The time point T0 to T1 is the sound signal SM1 from the mic (mic 1) 114-1, the time point T1 to T2 is the sound signal SM2v from the filter unit 115-2, the time point T2 to T3 is the sound signal SM3v from the filter unit 115-3, the time point T3 to T4 is the sound signal SM4v from the filter unit 115-4, and finally, T4 up to T5 is the sound signal SM1 from the mic (mic 1) 114-1 again.

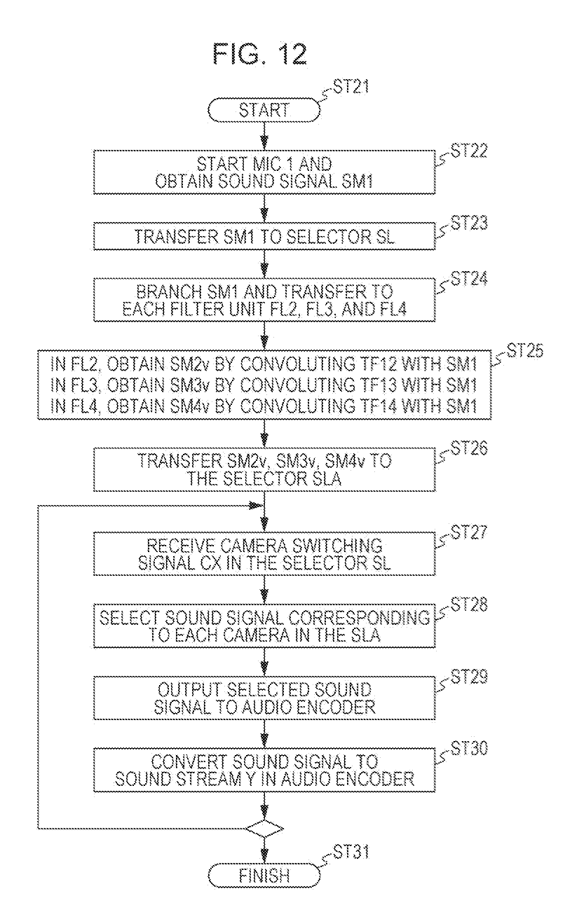

The flowchart of FIG. 12 shows an example of the flow of the operation of the sound system in the transmitting apparatus 110 of FIG. 9 above. First, in step ST21, the process is started, subsequently, in step ST22, the mic 1 is started and the sound signal SM1 is obtained. Then, in step ST23, the sound signal SM1 from the mic 1 is transmitted to the selector (SLA) 116.

Next, in step ST24, the sound signal SM1 is branched and transmitted to each filter unit. Then, in step ST25, in the filter unit (FL2) 115-2, the transmission function TF12 is convoluted with the sound signal SM1 and the sound signal SM2v is obtained at the imaging position of the camera 2. In addition, in step ST25, in the filter unit (FL3) 115-3, the transmission function TF13 is convoluted with the sound signal SM1 and the sound signal SM3v is obtained at the imaging position of the camera 3. Further, in step ST25, in the filter unit (FL4) 115-4, the transmission function TF14 is convoluted with the sound signal SM1 and the sound signal SM4v is obtained at the imaging position of the camera 4. Then, in step ST26, the sound signals SM2v, SM3v, and SM4v from each filter unit are transmitted to the selector (SLA) 116.

Next, in step ST27, the camera switching signal CX is received by the selector (SLA) 116. In addition, in step ST28, in the selector (SLA) 116, a sound signal is selected from the mic corresponding to the camera switched to by the selector (SLV) 112. In addition, in step ST29, the selected sound signal is output to the audio encoder 117. Then, in step ST30, the encoding of the sound signal is performed in the audio encoder 117 and a sound stream Y is obtained.

The processing from the above-described step ST27 to step ST30 is repeatedly performed. Then, for example, when there is an explicit termination operation from the user, in step ST31, the process is terminated.

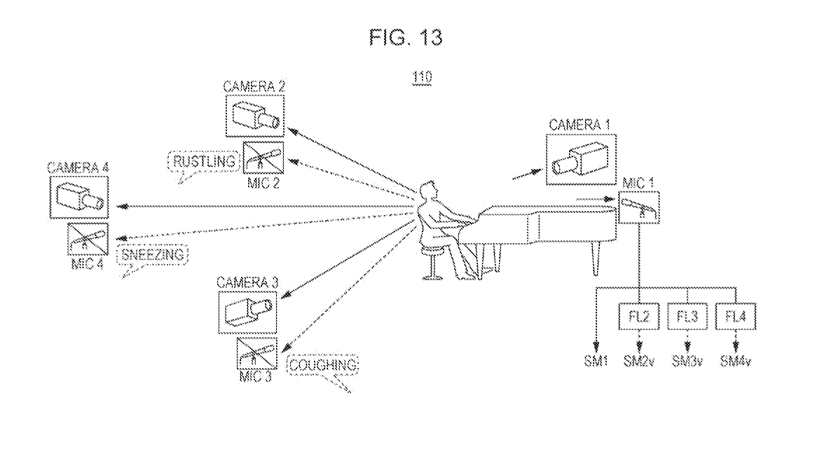

FIG. 13 schematically shows the entire transmitting apparatus 110. In such a case, the sound signals SM2v, SM3v, and SM4v at the imaging positions of the camera 2, the camera 3, and the camera 4 are not obtained by the microphones arranged at those imaging positions. The above sound signals are computed and obtained from the sound signal SM1 obtained by the mic 1 arranged at the imaging position of the camera 1 using the respective transmission functions at the filter units FL2, FL3, and FL4.

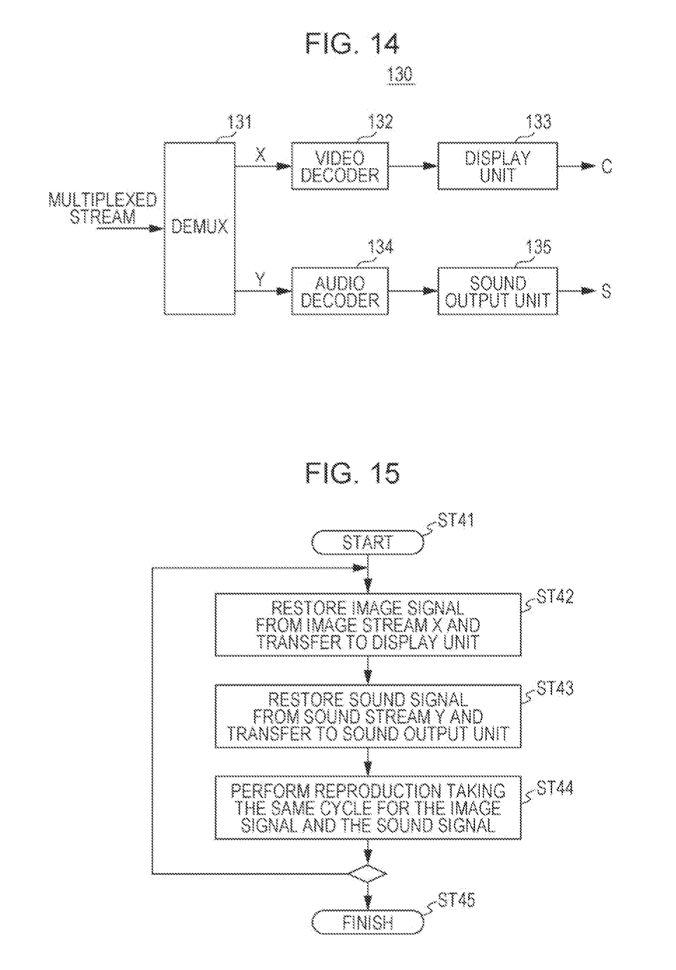

FIG. 14 shows a configuration example of a part of a receiving apparatus 130. The receiving apparatus 130 includes a demultiplexer (DEMUX) 131, a video decoder 132, a display unit 133, an audio decoder 134, and a sound output unit 135. The demultiplexer 131 respectively extracts the image stream X and the sound stream Y from the multiplexed stream sent from the transmitting apparatus 110. For example, in the case of broadcasting, the multiplexed stream is obtained by being received by a digital tuner (not shown).

The video decoder 132 obtains the image signal by decoding the image stream X extracted by the demultiplexer 131. The display unit 133 is configured by a display such as a liquid crystal display device or the like and displays an image C according to the image signal obtained by the video decoder 132. In addition, the audio decoder 134 obtains the sound signal by decoding the sound stream Y extracted by the demultiplexer 131. The sound output unit 135 is configured by a speaker, headphones, or the like, and outputs a sound S according to the sound signal obtained by the audio decoder 134.

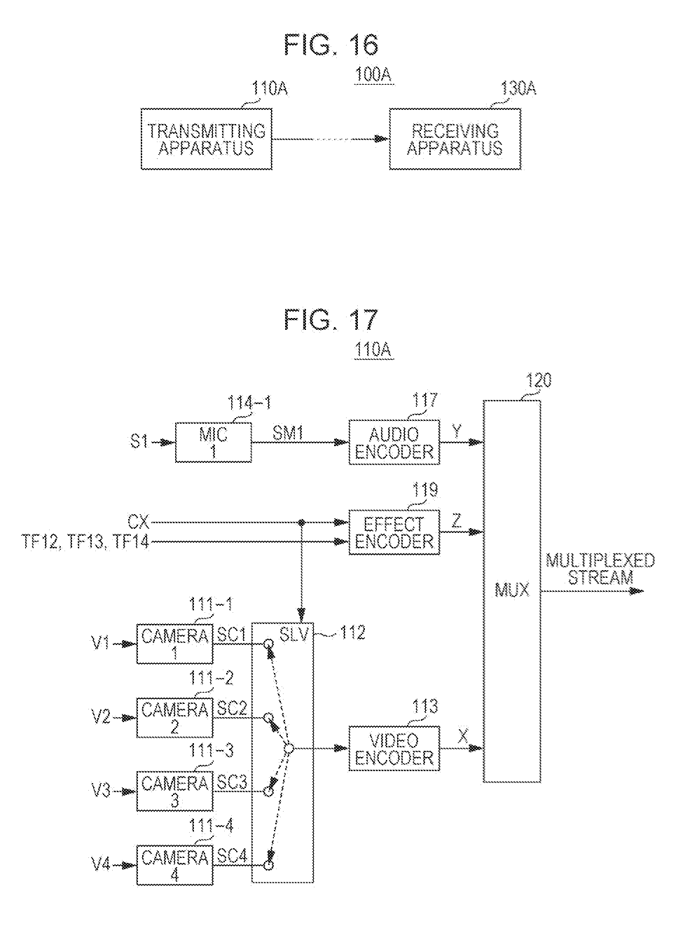

The flowchart of FIG. 15 shows an example of the flow of the operation of the receiving apparatus 130 of FIG. 14 above. First, in step ST41, the process is started, subsequently, in step ST42, the image stream X extracted by the demultiplexer 131 is decoded by the video decoder 132 and an image signal is restored, and this image signal is transmitted to the display unit 133. In addition, in step ST43, the sound stream Y extracted by the demultiplexer 131 is decoded by the audio decoder 134 and a sound signal is restored, and this sound signal is transmitted to the sound output unit 135.

Next, in step ST44, in the display unit 133 and the sound output unit 135, synchronization of the image signal and the sound signal is acquired and reproduction is performed. In other words, the image according to the image signal is displayed on the display unit 133, and the sound according to the sound signal is output in the sound output unit 135. Here, the synchronization of the image signal and the sound signal is not described above; however, it is completed by using a Presentation Time Stamp (PTS) or the like inserted into the image stream X and the sound stream Y.

The processing from the above-described step ST42 to step ST44 is repeatedly performed. Then, for example, when there is an explicit termination operation from the user, in step ST45, the process is terminated.

As described above, in the transmitting and receiving system 100 shown in FIG. 1, the sound signals at each imaging position corresponding to the camera switching are switched and transmitted to the receiving apparatus 130 from the transmitting apparatus 110. In such a case, the sound signals at the imaging positions of the camera 2, the camera 3, and the camera 4 are not obtained by the microphones arranged at the above imaging positions, but are computed and obtained from the sound signal SM1 obtained by the mic 1 arranged at the imaging position of the camera 1 using a transmission function. In such a case, since each sound signal is based on the sound signal SM1 having a good pick up state, each sound signal is high quality. Therefore, in the receiving apparatus 130, it is possible to provide the viewers with high quality sound signals at a plurality of imaging positions at each imaging apparatus.

### 2. SECOND EMBODIMENT

### Transmitting and Receiving System Using a Single Mic

FIG. 16 shows a configuration example of a transmitting and receiving system 100A as the second embodiment. This transmitting and receiving system 100A is configured by connecting a transmitting apparatus 110A and a receiving apparatus 130A using wires or wirelessly. For example, in the case of broadcasting, the transmitting apparatus 110A corresponds to the broadcasting station side and the receiving apparatus 130A corresponds to a television receiver in the home.

FIG. 17 shows a configuration example of a part of the transmitting apparatus 110A. In FIG. 17, portions corresponding to FIG. 9 are denoted by the same reference numerals and detailed description thereof will be omitted as appropriate. The transmitting apparatus 110A includes four cameras of a camera (camera 1) 111-1, a camera (camera 2) 111-2, a camera (camera 3) 111-3, and a camera (camera 4) 111-4, a selector (SLV) 112, and a video encoder 113. In addition, the transmitting apparatus 110A includes a mic (mic 1) 114-1, an audio encoder 117, an effect encoder 119, and a multiplexer (MUX) 120.

The camera 111-1, the camera 111-2, the camera 111-3, and the camera 111-4 are arranged at different imaging positions in a predetermined environment. For example, in a piano concert, the camera (camera 1) 111-1 is a camera for capturing the finger movements and facial expressions of the performers, the camera (camera 2) 111-2 is a camera for viewing the whole scene from above, the camera (camera 3) 111-3 is a camera for obtaining a viewpoint from below as if in the audience seats, and the camera (camera 4) 111-4 is a camera for capturing the entire venue from far away.

From image signals SC1, SC2, SC3, and SC4 of a moving image obtained by imaging images V1, V2, V3, and V4 with each camera, the selector 112 selectively extracts a predetermined image signal corresponding to a camera switching signal CX. The video encoder 113 generates an image stream X by performing encoding of the image signal extracted by the selector 112.

The mic (mic 1) 114-1 is arranged to be integral with or in the vicinity of the camera (camera 1) 111-1, and performs pick up at that position (pick up position). The mic (mic 1) 114-1 obtains a sound signal SM1 by picking up a sound S1 coming out of the piano (refer to FIG. 10). The audio encoder 117 generates a sound stream Y by performing encoding of the sound signal SM1 obtained by the mic (mic 1) 114-1.

The effect encoder 119 generates an effect stream Z by performing encoding of the transmission function TF. In such a case, the transmission function TF is switched according to the camera switching signal CX. In other words, when the camera switching signal CX is in a state of selecting the camera (camera 1) 111-1, the transmission function TF becomes 1. In addition, when the camera switching signal CX is in a state of selecting the camera (camera 2) 111-2, the transmission function TF becomes the transmission function TF12 (refer to FIG. 10) from the arrangement position of the mic (mic 1) 114-1 to the arrangement position of the camera (camera 2) 111-2 or the vicinity thereof.

In addition, when the camera switching signal CX is in a state of selecting the camera (camera 3) 111-3, the transmission function TF becomes the transmission function TF13 (refer to FIG. 10) from the arrangement position of the mic (mic 1) 114-1 to the arrangement position of the camera (camera 3) 111-3 or the vicinity thereof. In addition, when the camera switching signal CX is in a state of selecting the camera (camera 4) 111-4, the transmission function TF becomes the transmission function TF14 (refer to FIG. 10) from the arrangement position of the mic (mic 1) 114-1 to the arrangement position of the camera (camera 4) 111-4 or the vicinity thereof.

The multiplexer 120 respectively packetizes and multiplexes the image stream X, the sound stream Y, and the effect stream Z and generates a multiplexed stream. The transmitting apparatus 110A transmits the multiplexed stream to the receiving side. For example, in the case of broadcasting, the multiplexed stream is transmitted with the broadcast wave.

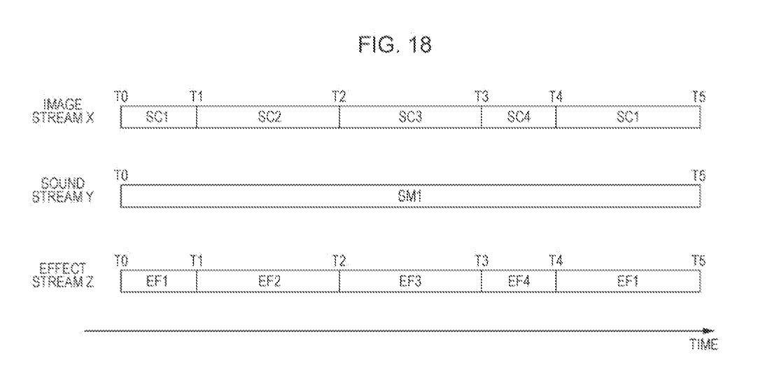

The upper part of FIG. 18 shows an example of the image stream X of a case where image signals from each camera are streamed. In the example, the time point T0 to T1 is the image signal SC1 from camera 1, the time point T1 to T2 is the image signal SC2 from camera 2, the time point T2 to T3 is the image signal SC3 from camera 3, the time point T3 to T4 is the image signal SC4 from camera 4, and finally, T4 up to T5 is the image signal SC1 from camera 1 again. The central part of FIG. 18 shows the sound stream Y, in which the sound signal SM1 from the mic 1 takes up all of from time point T0 to T5.

The lower part of FIG. 18 shows an example of the effect stream Z corresponding to the image stream X shown in the upper part. In the example, the time point T0 to T1 is the effect information EF 1 set to be picked up at the position of the camera 1, the time point T1 to T2 is the effect information EF 2 set to be picked up at the camera 2, and the time point T2 to T3 is the effect information EF 3 set to be picked up at the position of camera 3. In addition, the time point T3 to T4 is the effect information EF 4 set to be picked up at the position of the camera 4, and, finally, T4 up to T5 is the effect information EF 1 set to be picked up at the position of camera 1 again. Here, the transmission function is included in the effect information; however, the camera selection signal CX may also be included therein.

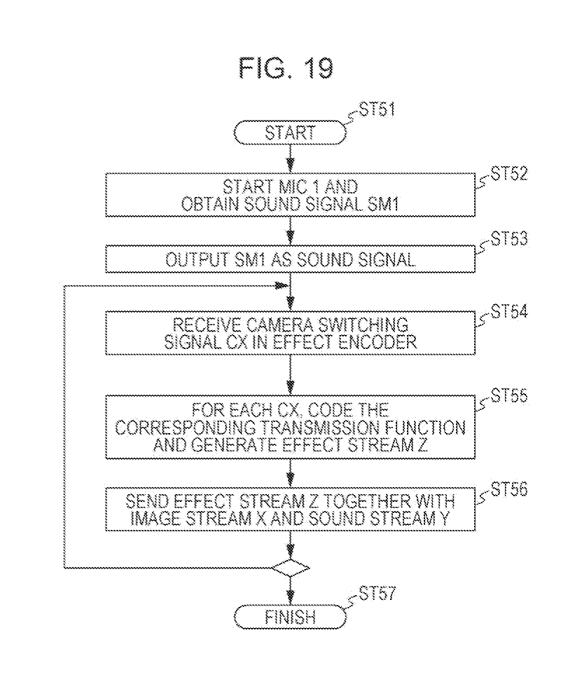

The flowchart of FIG. 19 shows an example of the flow of the operation of the sound system in the transmitting apparatus 110A of FIG. 17 above. First, in step ST51, the process is started, subsequently, in step ST52, the mic 1 is started and the sound signal SM1 is obtained. Then, in step ST53, the encoding of the sound signal SM1 from the mic 1 is performed in the audio encoder 117 and a sound stream Y is obtained.

Next, in step ST54, the camera switching signal CX is received by the effect encoder 119. Then, in step ST55, the encoding of the transmission function corresponding to the switching signal CX is performed in the effect encoder 119 and an effect stream Z is obtained.

Next, in step ST56, the image stream X, the sound stream Y, and the effect stream Z are packetized and multiplexed in the multiplexer 120 and the multiplexed stream is transmitted to the transmission side. The processing from the above-described step ST54 to step ST56 is repeatedly performed. Then, for example, when there is an explicit termination operation from the user, in step ST57, the process is terminated.

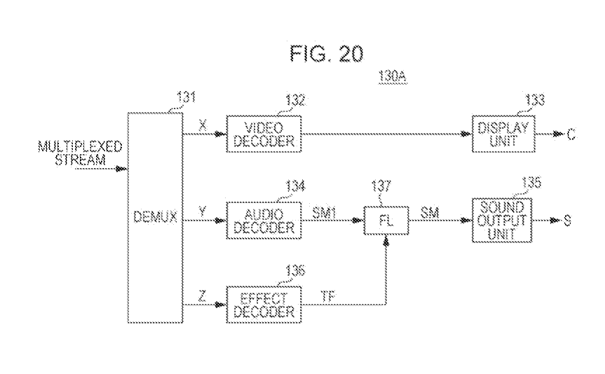

FIG. 20 shows a configuration example of a part of the receiving apparatus 130A. In FIG. 20, portions corresponding to FIG. 14 are denoted by the same reference numerals and detailed description thereof will be omitted as appropriate. The receiving apparatus 130A includes a demultiplexer (DEMUX) 131, a video decoder 132, a display unit 133, an audio decoder 134, an effect decoder 136, a filter unit 137, and a sound output unit 135.

The demultiplexer 131 respectively extracts the image stream X, the sound stream Y and the effect stream Z from the multiplexed stream sent from the transmitting apparatus 110. For example, in the case of broadcasting, the multiplexed stream is obtained by being received by a digital tuner (not shown). The video decoder 132 obtains the image signal by decoding the image stream X extracted by the demultiplexer 131. The display unit 133 is configured by a display such as a liquid crystal display device or the like and displays an image C according to the image signal obtained by the video decoder 132.

The audio decoder 134 obtains the sound signal SM1 by decoding the sound stream Y extracted by the demultiplexer 131. The effect decoder 136 obtains the transmission function TF by decoding the effect stream Z extracted by the demultiplexer 131. In such a case, when the image signal SC1 relating to the imaging of the camera 1 is output from the video decoder 132, the transmission function TF becomes 1. In addition, when the image signal SC2 relating to the imaging of the camera 2 is output from the video decoder 132, the transmission function TF becomes the transmission function TF12 from the arrangement position of the mic (mic 1) 114-1 to the arrangement position of the camera (camera 2) 111-2 or the vicinity thereof.

In addition, when the image signal SC3 relating to the imaging of the camera 3 is output from the video decoder 132, the transmission function TF becomes the transmission function TF13 from the arrangement position of the mic (mic 1) 114-1 to the arrangement position of the camera (camera 3) 111-3 or the vicinity thereof. In addition, when the image signal SC4 relating to the imaging of the camera 4 is output from the video decoder 132, the transmission function TF becomes the transmission function TF14 from the arrangement position of the mic (mic 1) 114-1 to the arrangement position of the camera (camera 4) 111-4 or the vicinity thereof.

The filter unit 137 convolutes a transmission function TF obtained by the effect decoder 136 with the sound signal SM1 obtained by the audio decoder 134, and obtains a sound signal SM. When the image signal SC1 relating to the imaging of the camera 1 is output from the video decoder 132, since the transmission function TF becomes 1, the above sound signal SM becomes the sound signal SM1 obtained by the mic (mic 1) 114-1. In addition, when the image signal SC2 relating to the imaging of the camera 2 is output from the video decoder 132, since the TF becomes TF12, the above sound signal SM becomes the sound signal SM2v at the arrangement position of the camera (camera 2) 111-2.

In addition, when the image signal SC3 relating to the imaging of the camera 3 is output from the video decoder 132, since the TF becomes TF13, the above sound signal SM becomes the sound signal SM3v at the arrangement position of the camera (camera 3) 111-3. In addition, when the image signal SC4 relating to the imaging of the camera 4 is output from the video decoder 132, since the TF becomes TF14, the above sound signal SM becomes the sound signal SM4v at the arrangement position of the camera (camera 4) 111-4.

The sound output unit 135 is configured by a speaker, headphones, or the like, and outputs a sound S according to the sound signal obtained by the filter unit 137.

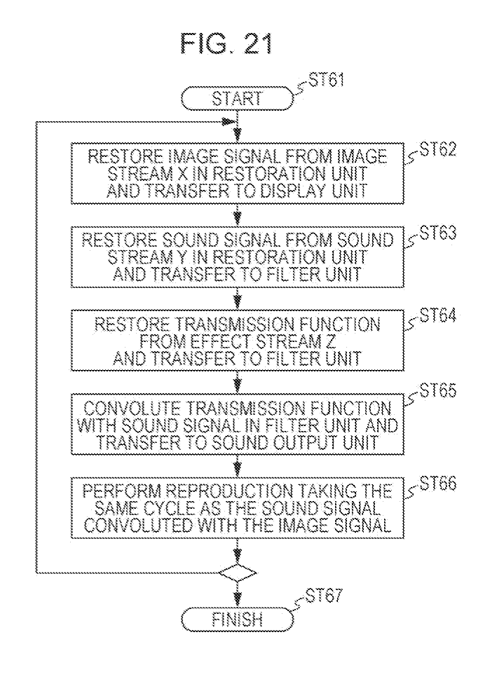

The flowchart of FIG. 21 shows an example of the flow of the operation of the receiving apparatus 130A of FIG. 20 above. First, in step ST61, the process is started. Subsequently, in step ST62, the image stream X extracted by the demultiplexer 131 is decoded by the video decoder 132 and an image signal is restored, and this image signal is transmitted to the display unit 133. In addition, in step ST63, the sound stream Y extracted by the demultiplexer 131 is decoded by the audio decoder 134 and a sound signal SM1 is restored, and this sound signal is transmitted to the filter unit (FL) 137.

Next, in step ST64, the effect stream Z extracted by the demultiplexer 131 is decoded by the effect decoder 136 and a transmission function TF is restored, and this transmission function TF is transmitted to the filter unit (FL) 137. Then, in step ST65, the transmission function TF is convoluted with the sound signal SM1 in the filter unit 137, whereby the sound signal SM corresponding to the camera switching (image signal switching) is obtained and is transmitted to the sound output unit 135.

Next, in step ST66, in the display unit 133 and the sound output unit 135, synchronization of the image signal and the sound signal is acquired and reproduction is performed. In other words, the image according to the image signal is displayed on the display unit 133, and the sound according to the sound signal is output in the sound output unit 135. Here, the synchronization of the image signal and the sound signal is not described above; however, it is completed by using a Presentation Time Stamp (PTS) or the like inserted into the image stream X and the sound stream Y.

The processing from the above-described step ST62 to step ST66 is repeatedly performed. Then, for example, when there is an explicit termination operation from the user, in step ST67, the process is terminated.

As described above, in the transmitting and receiving system 100A shown in FIG. 16, the sound signal SM1 obtained by the mic 1 arranged at the imaging position of the camera 1 and the transmission functions at each imaging position corresponding to the camera switching are switched and transmitted from the transmitting apparatus 110A to the receiving apparatus 130A. Then, in the receiving apparatus 130A, by the convolution calculation of the sound signal SM1 and transmission function, a sound signal is obtained at each imaging position corresponding to the camera switching.

In such a case, the sound signals at the imaging positions of the camera 2, the camera 3, and the camera 4 are not obtained by the microphones arranged at the above imaging positions, but are computed and obtained from the sound signal SM1 obtained by the mic 1 arranged at the imaging position of the camera 1 using a transmission function. In such a case, since each sound signal is based on the sound signal SM1 having a good pick up state, each sound signal is high quality. Therefore, in the receiving apparatus 130A, it is possible to provide the viewers with high quality sound signals at a plurality of imaging positions at each imaging apparatus.

### 3. MODIFICATION EXAMPLES

### Modification Example 1

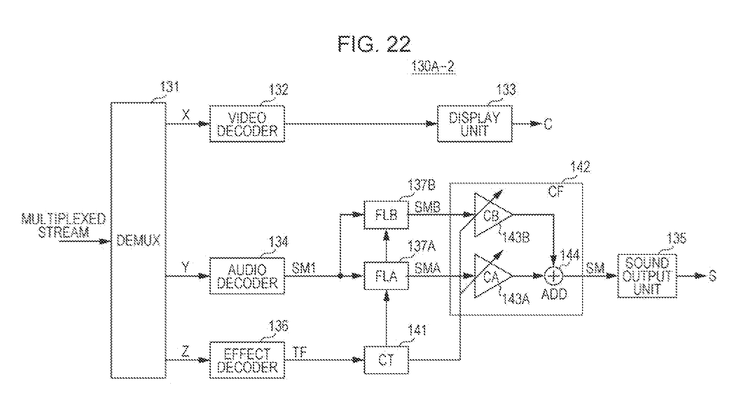

Here, in the receiving apparatus 130A shown in the above-described FIG. 20, the sound signal output from the filter unit 137 is discontinuous during the switching of the transmission function and there is a concern that discontinuous noise will be generated. FIG. 22 shows a configuration example of the receiving apparatus 130A-2 which is set to prevent the generation of such discontinuous noise. In FIG. 22, portions corresponding to FIG. 20 are denoted by the same reference numerals and detailed description thereof will be omitted as appropriate.

The receiving apparatus 130A-2 includes a demultiplexer (DEMUX) 131, a video decoder 132, a display unit 133, an audio decoder 134, an effect decoder 136, a filter unit (FLA) 137A, a filter unit (FLA) 137B, a control unit 141, a cross-fading unit (CF) 142, and a sound output unit 135.

The filter units 137A and 137B convolute a transmission function TF obtained by the effect decoder 136 with the sound signal SM1 obtained by the audio decoder 134, and obtain sound signals SMA and SMB. The control unit 141 sets the transmission function after switching to the filter unit 137A and sets the transmission function before switching to the filter unit 137B each time the transmission function TF obtained by the effect decoder 136 is switched.

The cross-fading unit 142 includes a gain adjusting unit (CA) 143A, a gain adjusting unit (CB) 143B, and an adder unit (ADD) 144. The gain adjusting unit 143A adjusts the coefficient (gain) A of the sound signal SMA obtained by the filter unit 137A. The gain adjusting unit 143A gradually changes the coefficient A from 1.0 to 0.0 from the time of the update of the transmission function to be set. On the other hand, the gain adjusting unit 143B adjusts the coefficient (gain) B of the sound signal SMB obtained by the filter unit 137B. The gain adjusting unit 143B gradually changes the coefficient B from 0.0 to 1.0 from the time of the update of the transmission function to be set. At this time, A+B=1.0.

The adder unit 144 adds the sound signal gain-adjusted by the gain adjusting unit 143A and the sound signal gain-adjusted by the gain adjusting unit 143B, and sets the sound signal SM. The sound output unit 135 outputs a sound S according to the sound signal SM obtained by the cross-fading unit 142. Although detailed description is omitted, the receiving apparatus 130A-2 and the other parts shown in FIG. 22 are configured in the same manner as the receiving apparatus 130A shown in FIG. 20.

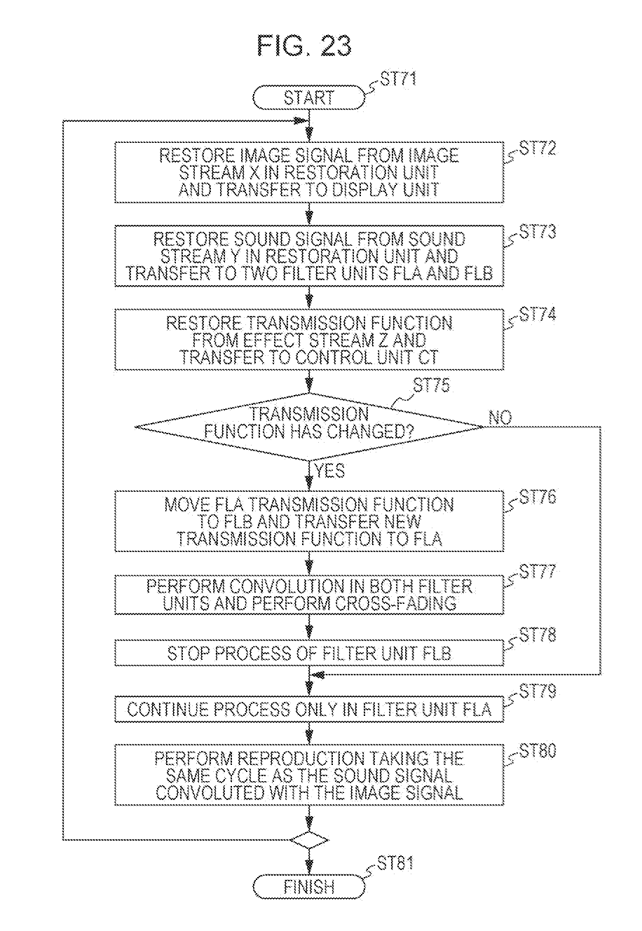

The flowchart of FIG. 23 shows an example of the flow of the operation of the receiving apparatus 130A-2 of FIG. 22 above. First, in step ST71, the process is started. Subsequently, in step ST72, the image stream X extracted by the demultiplexer 131 is decoded by the video decoder 132 and an image signal is restored, and this image signal is transmitted to the display unit 133. In addition, in step ST73, the sound stream Y extracted by the demultiplexer 131 is decoded by the audio decoder 134 and a sound signal SM1 is restored, and this sound signal SM1 is transmitted to the filter unit (FLA) 137A and the filter unit (FLB) 137B.

Next, in step ST74, the effect stream Z extracted by the demultiplexer 131 is decoded by the effect decoder 136 and a transmission function TF is restored, and this transmission function TF is transmitted to the control unit (CT) 141. Then, in step ST75, the control unit 141 determines whether the transmission function TF has changed.

When the transmission function has changed, in step ST76, the transmission function of the filter unit (FLA) 137A is moved to the filter unit (FLA) 137B, and a new transmission function is transmitted to the filter unit (FLA) 137A. Then, in step ST77, in the respective filter units 137A and 137B, the transmission function is convoluted with the sound signal SM1, and a cross-fading process is performed by the cross-fading unit (CF) 142.

Next, in step ST78, the process of the filter unit (FLB) 137B is stopped. After the above step ST78, the process of step ST79 is performed. Even when the transmission function is not changed in the above-described step ST75, the process of step ST79 is performed. In the above step ST79, the process of the convolution calculation is continued by the filter unit (FLA) 137A alone.

Next, in step ST80, in the display unit 133 and the sound output unit 135, synchronization of the image signal and the sound signal is acquired and reproduction is performed. In other words, the image according to the image signal is displayed on the display unit 133, and the sound according to the sound signal is output in the sound output unit 135. Here, the synchronization of the image signal and the sound signal is not described above; however, it is completed by using a Presentation Time Stamp (PTS) or the like inserted into the image stream X and the sound stream Y.

The processing from the above-described step ST72 to step ST80 is repeatedly performed. Then, for example, when there is an explicit termination operation from the user, in step ST81, the process is terminated.

As described above, in the receiving apparatus 130A-2 shown in FIG. 22, when there is a change in the transmission function TF, the cross-fading process is performed in the cross-fading unit 142, and the sound signal SM is gradually changed from the sound signal SMB according to the transmission function before the switch to the sound signal SMA according to the transmission function after the switch. Therefore, it is possible to prevent the generation of discontinuous noise. Here, the application of such a cross-fading process to the sound signal selected by the selector 112 of the transmitting apparatus 110 shown in the above-described FIG. 9 may be considered, and, similarly, it is possible to prevent the generation of discontinuous noise.

### Modification Example 2

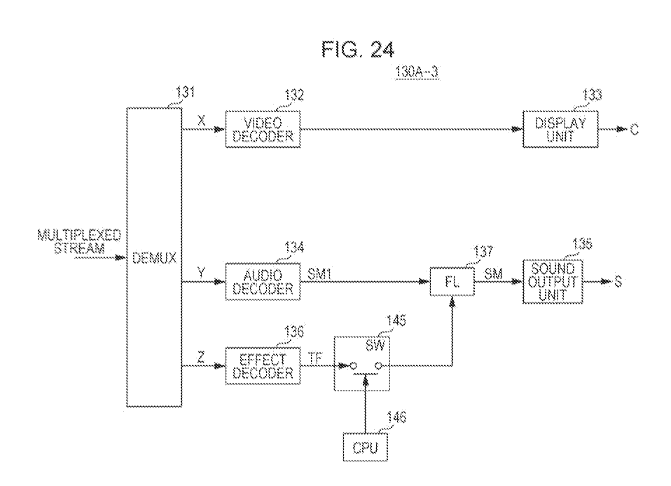

In addition, in the receiving apparatus 130A shown in the above-described FIG. 20, the sound signals at each imaging position corresponding to the camera switching are sequentially output from the filter unit 137. However, it may be considered that it is possible to arbitrarily fix the sound signals output from the filter unit 137 at predetermined camera positions. FIG. 24 shows a configuration example of the receiving apparatus 130A-3 in such a case. In FIG. 24, portions corresponding to FIG. 20 are denoted by the same reference numerals and detailed description thereof will be omitted as appropriate.

The receiving apparatus 130A-3 includes a demultiplexer (DEMUX) 131, a video decoder 132, a display unit 133, an audio decoder 134, an effect decoder 136, a filter unit (FL) 137, a control unit (CPU) 146, a switch unit (SW) 145, and a sound output unit 135.

The switch unit (SW) 145 transmits the transmission function TF obtained by the effect decoder 136 to the filter unit (FL) 137. The control unit 146 controls the turning on and off of the switch unit 145 according to a user operation. When there is a change in the transmission function TF being transmitted, the filter unit (FL) 137 performs an update of the transmission function to be convoluted with the sound signal SM1 obtained by the audio decoder 134.

In other words, in the filter unit (FL) 137, when there is no change in the transmission function TF being transmitted, the transmission function to be convoluted with the sound signal SM1 obtained by the audio decoder 134 remains the same. Therefore, by turning the switch unit 145 from on to off, the transmission function TF set at that timing in the filter unit (FL) 137 enters a state of continuing to be used, and the sound signal output from the filter unit 137 is fixed to a sound signal at a predetermined camera position.

In addition, from this state, by turning the switch unit 145 from off to on, the sound signals at each imaging position corresponding to the camera switching from the filter unit 137 enters a state of being sequentially output for the second time. The receiving apparatus 130A-3 and the other parts shown in FIG. 24 are configured in the same manner as the receiving apparatus 130A shown in FIG. 20.

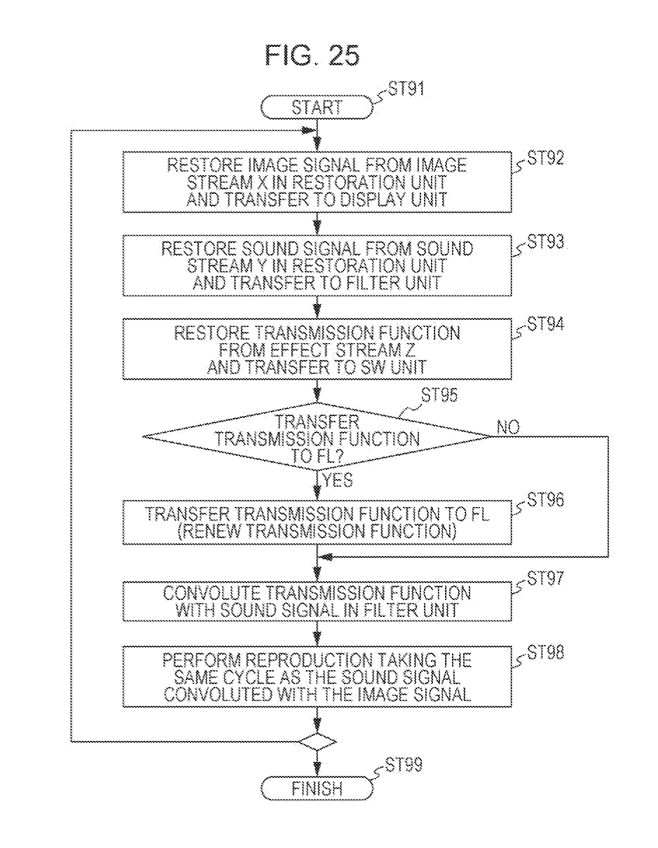

The flowchart of FIG. 25 shows an example of the flow of the operation of the receiving apparatus 130A-3 of FIG. 24 above. First, in step ST91, the process is started. Subsequently, in step ST92, the image stream X extracted by the demultiplexer 131 is decoded by the video decoder 132 and an image signal is restored, and this image signal is transmitted to the display unit 133. In addition, in step ST93, the sound stream Y extracted by the demultiplexer 131 is decoded by the audio decoder 134 and a sound signal SM1 is restored, and this sound signal SM1 is transmitted to the filter unit (FL) 137.

Next, in step ST94, the effect stream Z extracted by the demultiplexer 131 is decoded by the effect decoder 136 and a transmission function TF is restored, and this transmission function TF is transmitted to the switch unit 145. Then, in step ST95, it is determined whether the transmission function TF is transmitted to the filter unit 137. When transmission is to be performed, in step ST96, the switch unit 145 is turned on and the transmission function TF is transmitted to the filter unit 137. In this manner, when there is a change in the transmission function TF, the transmission function in the filter unit 137 is updated.

After the process of step ST96, the process of step ST97 is performed. When the transmission is not performed in the above-described step ST95, the process of step ST97 is performed immediately. In step ST97, the transmission function is convoluted with the sound signal SM1 in the filter unit 137. Then, in step ST98, in the display unit 133 and the sound output unit 135, synchronization of the image signal and the sound signal is acquired and reproduction is performed. In other words, the image according to the image signal is displayed on the display unit 133, and the sound according to the sound signal is output in the sound output unit 135. Here, the synchronization of the image signal and the sound signal is not described above; however, it is completed by using a Presentation Time Stamp (PTS) or the like inserted into the image stream X and the sound stream Y.

The processing from the above-described step ST92 to step ST98 is repeatedly performed. Then, for example, when there is an explicit termination operation from the user, in step ST99, the process is terminated.

As described above, in the receiving apparatus 130A-3 shown in FIG. 24, whether or not the transmission function TF obtained by the effect decoder 136 is transmitted to the filter unit 137 is controlled by the switch unit 145. For this reason, it is possible to arbitrarily switch between the state where the sound signals at each imaging position corresponding to the camera switching are sequentially output and the state where the sound signal at the predetermined camera position is continuously output.

### Modification Example 3

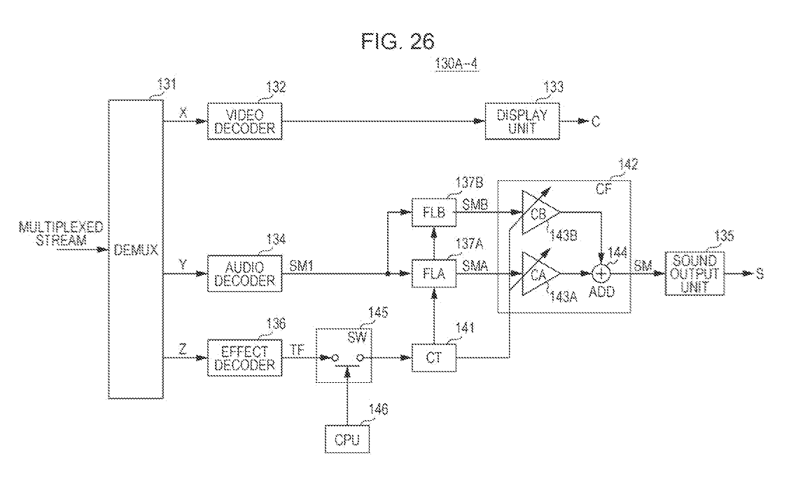

In addition, combining the functions of the above-described receiving apparatus 130A-2 of FIG. 22 and the receiving apparatus 130-3 of FIG. 24 may be considered. FIG. 26 shows a configuration example of the receiving apparatus 130-4 in such a case. In FIG. 26, portions corresponding to FIG. 22 and FIG. 24 are denoted by the same reference numerals and detailed description thereof will be omitted.

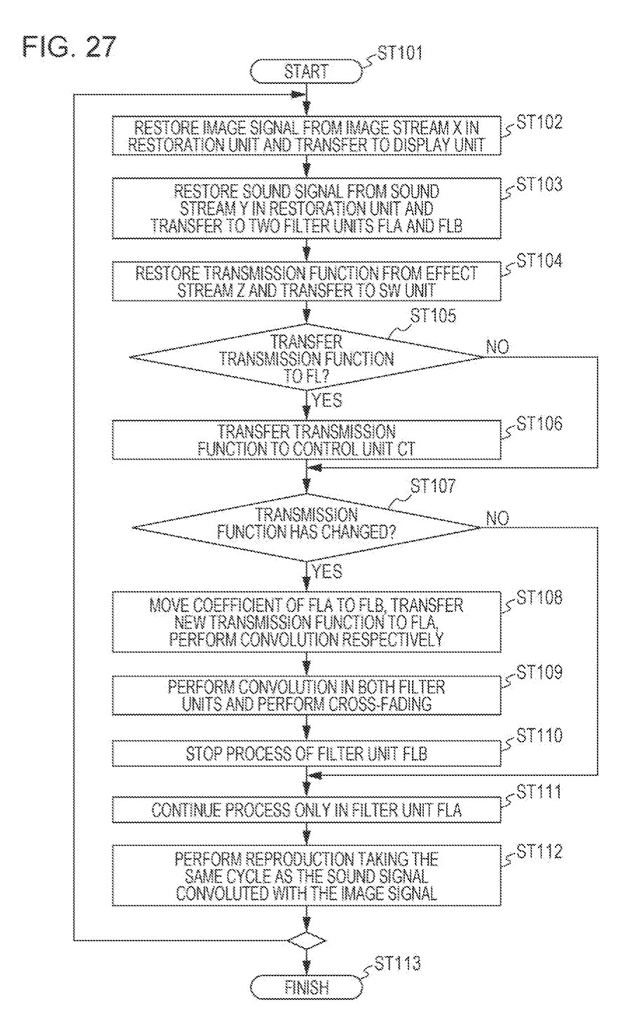

The flowchart of FIG. 27 shows an example of the flow of the operation of the receiving apparatus 130A-4 of FIG. 26 above. First, in step ST101, the process is started. Subsequently, in step ST102, the image stream X extracted by the demultiplexer 131 is decoded by the video decoder 132 and an image signal is restored, and this image signal is transmitted to the display unit 133. In addition, in step ST103, the sound stream Y extracted by the demultiplexer 131 is decoded by the audio decoder 134 and a sound signal SM1 is restored, and this sound signal SM1 is transmitted to the filter unit (FLA) 137A and the filter unit (FLB) 137B.

Next, in step ST104, the effect stream Z extracted by the demultiplexer 131 is decoded by the effect decoder 136 and a transmission function TF is restored, and this transmission function TF is transmitted to the switch unit 145. Then, in step ST105, it is determined whether the transmission function TF is transmitted to the filter unit 137. When transmission is to be performed, in step ST106, the switch unit 145 is turned on and the transmission function TF is transmitted to the control unit (CT) 141. In this manner, when there is a change in the transmission function TF, it is possible to update the transmission function in the filter units 137A and 137B through the control unit (CT) 141.

After the process of step ST106, the process of step ST107 is performed. When the transmission is not performed in the above-described step ST105, the process of step ST107 is performed immediately. In step ST107, the control unit 141 determines whether the transmission function TF has changed.

When the transmission function has changed, in step ST108, the transmission function of the filter unit (FLA) 137A is moved to the filter unit (FLA) 137B, and a new transmission function is transmitted to the filter unit (FLA) 137A. Then, in step ST109, in the respective filter units 137A and 137B, the transmission function is convoluted with the sound signal SM1, and a cross-fading process is performed by the cross-fading unit (CF) 142.

Next, in step ST110, the process of the filter unit (FLB) 137B is stopped. After the above step ST108, the process of step ST111 is performed. Even when the transmission function is not changed in the above-described step ST107, the process of step ST111 is performed. In the above step ST111, the process of the convolution calculation is continued by the filter unit (FLA) 137A alone.

Next, in step ST112, in the display unit 133 and the sound output unit 135, synchronization of the image signal and the sound signal is acquired and reproduction is performed. In other words, the image according to the image signal is displayed on the display unit 133, and the sound according to the sound signal is output in the sound output unit 135. Here, the synchronization of the image signal and the sound signal is not described above; however, it is completed by using a Presentation Time Stamp (PTS) or the like inserted into the image stream X and the sound stream Y.

The processing from the above-described step ST102 to step ST112 is repeatedly performed. Then, for example, when there is an explicit termination operation from the user, in step ST113, the process is terminated.

As described above, in the receiving apparatus 130A-4 shown in FIG. 26, in the same manner as the receiving apparatus 130A-2 shown in the above-described FIG. 22, it is possible to prevent the generation of discontinuous noise, and, in the same manner as the receiving apparatus 130A-3 shown in the above-described FIG. 24, it is possible to arbitrarily switch between the state where the sound signals at each imaging position corresponding to the camera switching are sequentially output and the state where the sound signal at the predetermined camera position is continuously output.

### Modification Example 4

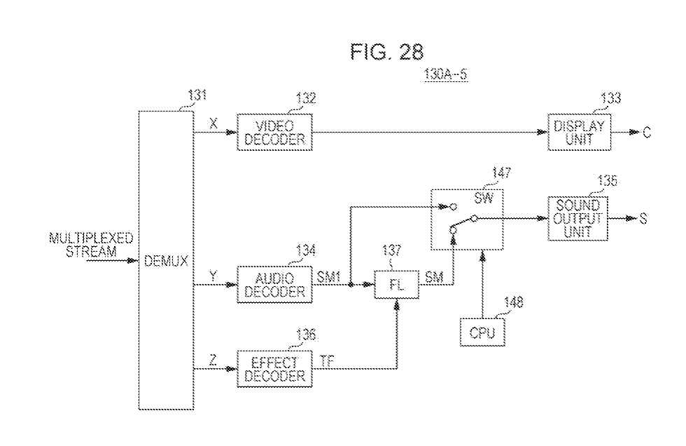

In addition, in the receiving apparatus 130A shown in the above-described FIG. 20, the sound signals at each imaging position corresponding to the camera switching are sequentially output from the filter unit 137. It may be considered that the sound signal SM1 obtained by the audio decoder 134 and the sound signal SM obtained by the filter unit 137 may be set to be arbitrarily switchable by the user. FIG. 28 shows a configuration example of the receiving apparatus 130A-5 in such a case. In FIG. 28, portions corresponding to FIG. 20 are denoted by the same reference numerals and detailed description thereof will be omitted as appropriate.

The receiving apparatus 130A-5 includes a demultiplexer (DEMUX) 131, a video decoder 132, a display unit 133, an audio decoder 134, an effect decoder 136, a filter unit (FL) 137, a switch unit (SW) 147, a control unit (CPU) 148, and a sound output unit 135.

The switch unit (SW) 147 selectively extracts the sound signal SM1 obtained by the audio decoder 134 and the sound signal SM obtained by the filter unit 137, and performs transmission thereof to the sound output unit 135. The control unit 148 controls the selection of the switch unit 147 according to a user operation. The receiving apparatus 130A-5 and the other parts shown in FIG. 28 are configured in the same manner as the receiving apparatus 130A shown in FIG. 20.

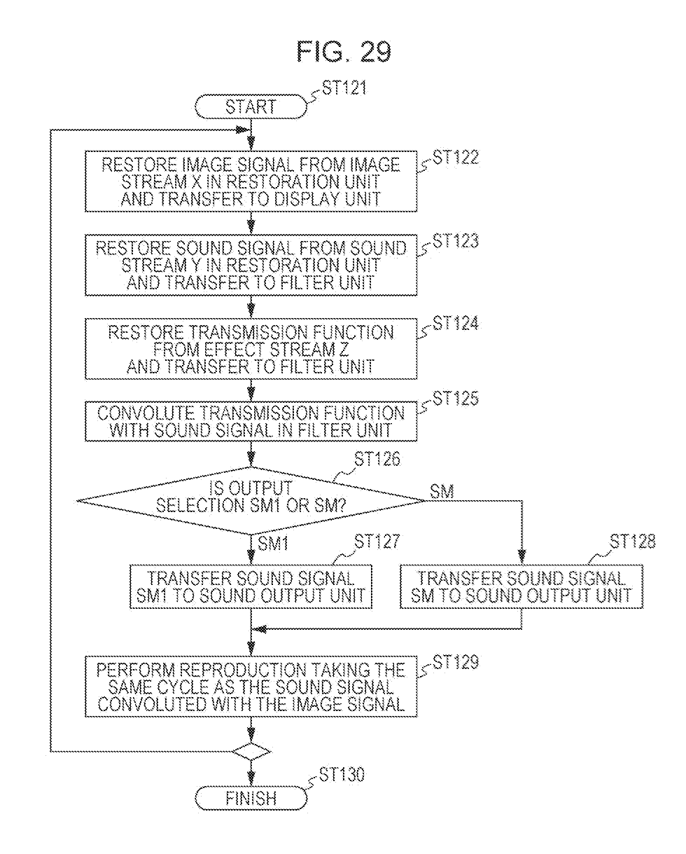

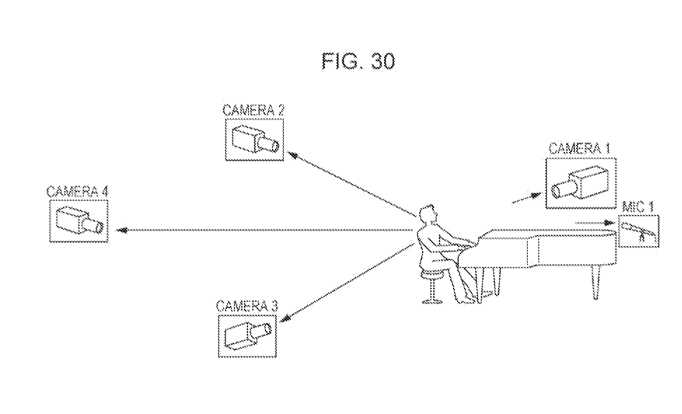

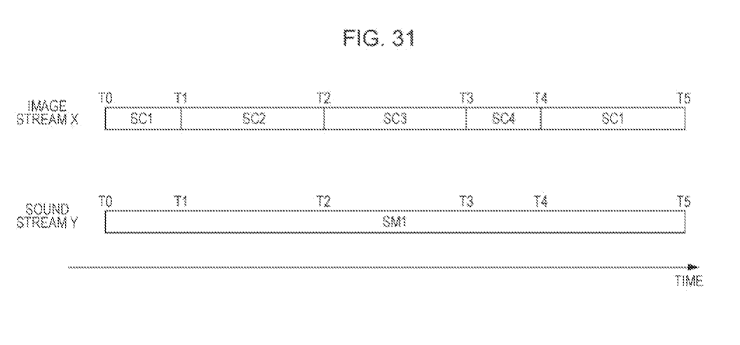

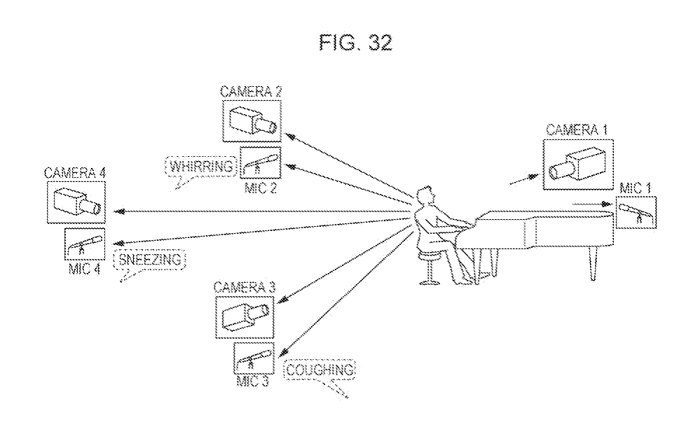

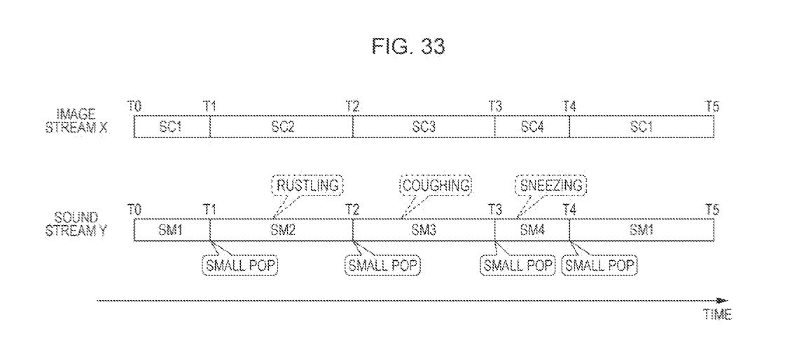

The flowchart of FIG. 29 shows an example of the flow of the operation of the receiving apparatus 130A-5 of FIG. 28 above. First, in step ST121, the process is started. Subsequently, in step ST122, the image stream X extracted by the demultiplexer 131 is decoded by the video decoder 132 and an image signal is restored, and this image signal is transmitted to the display unit 133. In addition, in step ST123, the sound stream Y extracted by the demultiplexer 131 is decoded by the audio decoder 134 and a sound signal SM1 is restored, and this sound signal is transmitted to the filter unit (FL) 137.

Next, in step ST124, the effect stream Z extracted by the demultiplexer 131 is decoded by the effect decoder 136 and a transmission function TF is restored, and this transmission function TF is transmitted to the filter unit (FL) 137. Then, in step ST125, the transmission function TF is convoluted with the sound signal SM1 in the filter unit 137, whereby the sound signal SM corresponding to the camera switching (image signal switching) is obtained.

Next, in step ST126, it is determined whether the sound signal SM1 from the audio decoder 134 is selected, or the sound signal SM from the filter unit 137 is selected. When the sound signal SM1 is selected, in step ST127, the sound signal SM1 is selected by the switch unit 147 and transmitted to the sound output unit 135. On the other hand, when the sound signal SM is selected, in step ST128, the sound signal SM is selected by the switch unit 147 and transmitted to the sound output unit 135.

Next, in step ST129, in the display unit 133 and the sound output unit 135, synchronization of the image signal and the sound signal is acquired and reproduction is performed. In other words, the image according to the image signal is displayed on the display unit 133, and the sound according to the sound signal is output in the sound output unit 135. Here, the synchronization of the image signal and the sound signal is not described above; however, it is completed by using a Presentation Time Stamp (PTS) or the like inserted into the image stream X and the sound stream Y.

The processing from the above-described step ST122 to step ST126 is repeatedly performed. Then, for example, when there is an explicit termination operation from the user, in step ST130, the process is terminated.

As described above, in the receiving apparatus 130A-5 shown in FIG. 28, the sound signal SM1 obtained by the audio decoder 134 and the sound signal SM obtained by the filter unit 137 are selectively extracted by the switch unit 147 and transmitted to the sound output unit 135. In other words, it is possible for the user to arbitrarily switch between the sound signal SM1 and the sound signal SM.

In addition, the present technology is capable of taking the following configuration.

(1) An audio signal processing apparatus including: a selection signal acquisition unit acquiring a selection signal indicating a selection of a predetermined moving image from a plurality of moving images imaged at different imaging positions in a predetermined environment; and an audio signal generating unit generating an audio signal at an imaging position of the predetermined moving image, based on an audio signal picked up at an audio pick up position in the predetermined environment and a transmission function determined according to a relative position of the imaging position of the predetermined moving image and the audio pick up position according to the selection signal.

(2) The audio signal processing apparatus according to (1), in which, when there is a switch of the predetermined moving image indicated by the selection signal, the audio signal generating unit generates the audio signal at the imaging position of the predetermined moving image before the switch and the audio signal of the imaging position of the predetermined moving image after the switch in parallel, and obtains an audio signal of a single system according to a cross-fading process.

(3) The audio signal processing apparatus according to (1) or (2), further including: an encoding unit encoding the audio signal generated by the audio signal generating unit and obtaining an audio stream.

(4) The audio signal processing apparatus according to (3), further including: a stream receiving unit receiving the audio stream obtained by encoding the picked up audio signal and an effect stream obtained by encoding the transmission function corresponding to the imaging position of the predetermined moving image indicated by the selection signal, a first decoding unit decoding the audio stream and obtaining an audio signal, and a second decoding unit decoding the effect stream and obtaining the transmission function.

(5) The audio signal processing apparatus according to (4), wherein the audio signal generating unit further includes a control unit controlling stopping or restarting of changes of the transmission function according to the selection signal.

(6) The audio signal processing apparatus according to (4) or (5), wherein the audio signal generating unit further includes an output selection unit selectively outputting the generated audio signal or the picked up audio signal.

(7) An audio signal processing method including: acquiring a selection signal indicating a selection of a predetermined moving image from a plurality of moving images imaged at different imaging positions in a predetermined environment; and generating an audio signal at an imaging position of the predetermined moving image, based on an audio signal picked up at an audio pick up position in the predetermined environment and a transmission function determined according to a relative position of the imaging position of the predetermined moving image and the audio pick up position according to the selection signal.

(8) A program causing a computer to execute: acquiring a selection signal indicating a selection of a predetermined moving image from a plurality of moving images imaged at different imaging positions in a predetermined environment; and generating an audio signal at an imaging position of the predetermined moving image, based on an audio signal picked up at an audio pick up position in the predetermined environment and a transmission function determined according to a relative position of the imaging position of the predetermined moving image and the audio pick up position according to the selection signal.

(9) A signal processing system including: a plurality of cameras arranged at different imaging positions in a predetermined environment; a moving image selection unit selecting a predetermined moving image from a plurality of moving images imaged by the plurality of cameras; microphones arranged at pick up positions in the predetermined environment; and an audio signal generating unit generating an audio signal at the imaging position of the predetermined moving image based on an audio signal picked up at an audio pick up position in the predetermined environment according to a selection signal indicating the selection of the predetermined moving image and a transmission function determined according to a relative position of the imaging position of the predetermined moving image and the audio pick up position.

The present technology contains subject matter related to that disclosed in Japanese Priority Patent Application JP 2011-286980 filed in the Japan Patent Office on Dec. 27, 2011, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An audio signal processing apparatus comprising:
a selection signal acquisition unit acquiring a selection signal indicating a selection of a predetermined moving image from a plurality of moving images imaged at different imaging positions in a predetermined environment; and
an audio signal generating unit generating an audio signal at the imaging position of the predetermined moving image, based on an audio signal picked up at an audio pick up position in the predetermined environment and a transmission function determined according to a relative position of the imaging position of the predetermined moving image and the audio pick up position according to the selection signal.

2. The audio signal processing apparatus according to claim 1,
wherein, when there is a switch of the predetermined moving image indicated by the selection signal, the audio signal generating unit generates the audio signal at the imaging position of the predetermined moving image before the switch and the audio signal of the imaging position of the predetermined moving image after the switch in parallel, and obtains an audio signal of a single system according to a cross-fading process.

3. The audio signal processing apparatus according to claim 1, further comprising:
an encoding unit encoding the audio signal generated by the audio signal generating unit and obtaining an audio stream.

4. The audio signal processing apparatus according to claim 3, further comprising:
a stream receiving unit receiving the audio stream obtained by encoding the picked up audio signal and an effect stream obtained by encoding the transmission function corresponding to the imaging position of the predetermined moving image indicated by the selection signal,
a first decoding unit decoding the audio stream and obtaining an audio signal, and
a second decoding unit decoding the effect stream and obtaining the transmission function.

5. The audio signal processing apparatus according to claim 1,
wherein the audio signal generating unit further includes a control unit controlling stopping or restarting of changes of the transmission function according to the selection signal.

6. The audio signal processing apparatus according to claim 1,
wherein the audio signal generating unit further includes an output selection unit selectively outputting the generated audio signal or the picked up audio signal.

7. An audio signal processing method comprising:
acquiring a selection signal indicating a selection of a predetermined moving image from a plurality of moving images imaged at different imaging positions in a predetermined environment; and
generating an audio signal at an imaging position of the predetermined moving image, based on an audio signal picked up at an audio pick up position in the predetermined environment and a transmission function determined according to a relative position of the imaging position of the predetermined moving image and the audio pick up position according to the selection signal.

8. A program causing a computer to execute:
acquiring a selection signal indicating a selection of a predetermined moving image from a plurality of moving images imaged at different imaging positions in a predetermined environment; and
generating an audio signal at an imaging position of the predetermined moving image, based on an audio signal picked up at an audio pick up position in the predetermined environment and a transmission function determined according to a relative position of the imaging position of the predetermined moving image and the audio pick up position according to the selection signal.

9. A signal processing system comprising:
a plurality of cameras arranged at different imaging positions in a predetermined environment;
a moving image selection unit selecting a predetermined moving image from a plurality of moving images imaged by the plurality of cameras;
microphones arranged at pick up positions in the predetermined environment; and
an audio signal generating unit generating an audio signal at the imaging position of the predetermined moving image based on an audio signal picked up at an audio pick up position in the predetermined environment according to a selection signal indicating the selection of the predetermined moving image and a transmission function determined according to a relative position of the imaging position of the predetermined moving image and the audio pick up position.
